(19) United States
(12) Patent Application Publication
(10) Pub. No.: US 2010/0015294 A1
(43) Pub. Date: Jan. 21, 2010

(54) CAMILLEON COOKIE RECIPE COLLECTION

(76) Inventor: Camille Sharee Alexander-Munjone, Tampa, FL (US)

Correspondence Address: Camille Alexander-Munjone, PO Box 341583, Tampa, FL, 33694, US

(21) Appl. No.: 12/176,531

(22) Filed: Jul. 21, 2008

(51) Int. Cl. A21D 13/00; A21D 2/08; A21D 10/00

(52) U.S. Cl. 426/94; 426/558; 426/553

(57) ABSTRACT

The Camilleon Cookie Collection brings a new flavor of cookies to the market. They are lighter, flavorful, and delightful to the palate. Many kinds of cookies can be created with the use of the base recipe, and more cookies are yielded per batch. The cookies have natural preservative and the doe can last for more than a month. The cookie itself can be frozen and later warmed up again to taste as fresh as the first time they were baked.

### BACKGROUND OF INVENTION

Most cookie doe is made with large amounts of sugar and butter. It is normally two sticks of butter or margarine. These two ingredients by themselves make the cookie heavy and too sweet. If you try to put more flour to the recipe, it makes the cookie hard and heavy. With the current cookie recipes there is no way of adding other wet ingredient because the cookie will not take shape.

### BRIEF SUMMARY OF THE INVENTION

My Camilleon Cookie Base Recipe and added ingredient per cookie type are not as sweet as the original cookies sold on the market. I have discovered a way to add more ingredients and balance the moisture with waffle mix to expand the doe. The waffle mix has the right balance of dry ingredients to keep the cookie from being heavy like flour would make them. The amount of cookies yielded from each batch is increased to more than 24 cookies, and this is another reason why the sugar per cookie ratio is smaller. I am able to reduce the amount of butter applied to the cookie in some of the recipes as well. However, even when the recipe calls for 2 sticks of butter or margarine, the cookie doe is expanded by the waffle mix, making the butter per cookie ratio smaller also. With the base recipe I am able to create any cookie I would like to. It is a perfect opportunity to create new flavors of cookies, and reduce the amount of saturated fat that is in each cookie.

### DETAILED DESCRIPTION OF THE INVENTION

The waffle mix makes a big difference in the cookie recipes and should be folded into each cookie recipe to form the cookie doe. This is a new concept all together to cookies and specifically the cookies mentioned in this collection. The ingredient in each cookie specified in this collection contains different measurements than the cookie recipes that are currently available in the market. The Base recipe should be combined with the ingredient listed under each type of cookie on the second page. For example, if the Base recipe already has 13 Tablespoons of Butter or Margarine and the Red velvet cookie recipe asks for 3 Tablespoons of Butter or Margarine these two amounts should be added together to make 16 Tablespoons of Butter or Margarine. Once the cookie's entire ingredient is added to the base recipe, you would continue to follow the mixing process provided on the first page of this document.

The Base Recipe is as follows:

| | | |
|---|---|---|
| 1½ | cup | Self Rising Flour (Can be substituted w/ All purpose |
| | | or whole wheat flour) |
| 1 | teaspoon | Baking Soda |
| ½ | teaspoon | Pure Vanilla Extract (or the flavor each cookie |
| | | calls for) |
| 13 | tablespoons | Butter or Margarine |
| 1½ | cup | Granulated Sugar (or 1¼ cup Granulated and ¼ |
| | | cup brown sugar, light/dark for buttermilk chocolate |
| | | chip cookie) |
| 1 | | Large Egg |
| 2 | cups | Belgian Waffle Mix; you can add until you get the |
| | | cookie doe texture you desire |
| ½ | teaspoon | Salt (Optional) |

The Mixing Process: Preheat oven to 350 degree.
Mix together in a large bowl the butter or margarine and sugar until fluffy, then add egg, vanilla extract (or the flavor each cookie calls for), and set aside. In another bowl Mix together the dry ingredients except the waffle mix. Add the flour mixture to the wet ingredient and mix until smooth. Lastly fold in the waffle mix to the mixture and mix until cookie doe has formed. You may add waffle mix until you reach the cookie doe consistency desired. Put the doe into the refrigerator for half an hour to an hour for extra firmness or you can bake the cookies from the room temperature doe. Bake for 7 up to 12 minutes or until golden brown. Let cool for 5 minutes on a cookie sheet or cooling surface. This doe yields more than 24 regular sized cookies.

The following pages give the ingredient for each cookie type that is to be *added* to the basic ingredient above. Please pay close attention to sugar ingredient as the amount of sugar or kind of sugar may change completely. **Abbreviations: Tsp=Teaspoon, Tbsp=Tablespoon, c=Cup, Pkg=Package, Lg=Large, oz=Ounce

BUTTERMILK CHOCOLATE CHIP COOKIE:

| ½ | Cup | Grounded Chocolate Chips |
|---|---|---|
| 1 | Cup | Semisweet Large Chocolate Chips |
| 1¼ | Cup | Granulated Sugar (in place of 1½ cup sugar) |
| ¼ | Cup | Brown Sugar (Light or Dark) |
| ½ | Cup | Butter Milk |
| 1 | Tsp | Vanilla Extract |

WHOLE WHEAT ALMOND CHOCOLATE CHIP COOKIE:

| | | |
|---|---|---|
| ½ | Cup | Grounded Chocolate Chips |
| 1 | Cup | Semisweet Large Chocolate Chips |
| 1 | Cup | Granulated Sugar (In place of Sugar ingredient in |
| | | base recipe) |
| ½ | Cup | Brown Sugar (In place of Sugar Ingredient in base recipe) |
| ¼ | Cup | Butter Milk |
| 1 | Tsp | Almond Extract (in place of Vanilla) |
| ½ | Cup | Sliced Almonds |
| 1½ | Cup | Whole Wheat Flour (in place of white flour) |
| ½ | Tsp | Nut Meg |

RED VELVET COOKIE:

| | | |
|---|---|---|
| 1 | Cup | White Flour (All purpose or Self Rising) |
| 1 | Tsp | Dark Cocoa |
| 1 | Tsp | Vinegar |
| ¼ | Cup | Buttermilk |
| 1 or 2 | oz | Red Food Color |
| 3 | Tbsp | Butter or Margarine |
| 1 | Cup | White Choc. Chips |
| ½ | Cup | Roasted Chopped Walnuts |

GERMAN CHOCOLATE COOKIE:

| | | |
|---|---|---|
| 3 | Tbsp | Butter or Margarine |
| ½ | Cup | Water |
| 1 | Pkg | German Sweet Chocolate (melt in the ½ cup water) |
| 1 | Tsp | Vanilla Extract |
| ¼ | Cup | Butter Milk |
| 1 | Cup | Pecan Coconut Icing |
| 1 | Cup | Shredded Coconut |

LEMON POUND CAKE COOKIE:

| | | |
|---|---|---|
| 3 | Tbsp | Butter or Margarine |
| ½ | Cup | Sour Cream |
| 1 | Tsp | Lemon Extract (in place of Vanilla) |
| 1 | Cup | Flour (All purpose or self rising) |
| 1 | Tsp | Baking Powder (in place of Baking soda) |

1. I claim the Base Recipe of the Camilleon Cookie Recipe Collection, given on the first page, as my invention, and request the protection of its duplication from unauthorized parties who attempt to make and sale the doe, or the cookie it produces without my authorization.

2. I claim the Buttermilk Chocolate Chip Cookie recipe dependent of the base recipe of the Camilleon Cookie Recipe Collection as my invention, and request the protection of its duplication from unauthorized parties who attempt to make and sale the doe, or the cookie it produces without my authorization.

3. I claim the Whole Wheat Almond Chocolate Chip Cookie recipe dependent of the base recipe of the Camilleon Cookie Recipe Collection as my invention, and request the protection of its duplication from unauthorized parties who attempt to make and sale the doe, or the cookie it produces without my authorization.

4. I claim the Red Velvet Cookie recipe dependent of the base recipe of the Camilleon Cookie Recipe Collection as my invention, and request the protection of its duplication from unauthorized parties who attempt to make and sale the doe, or the cookie it produces without my authorization.

5. I claim the German Chocolate Cookie recipe dependent of the base recipe of the Camilleon Cookie Recipe Collection as my invention, and request the protection of its duplication from unauthorized parties who attempt to make and sale the doe, or the cookie it produces without my authorization.

6. I claim the Lemon Pound Cake Cookie recipe of the Camilleon Cookie Recipe Collection as my invention, and request the protection of its duplication from unauthorized parties who attempt to make and sale the doe, or the cookie it produces without my authorization.
